(19) United States
(12) Patent Application Publication
(10) Pub. No.: US 2014/0143034 A1
(43) Pub. Date: May 22, 2014

(54) OPTICAL COMMUNICATIONS VIA ILLUMINATION LIGHT OF LED LIGHTING SYSTEM

(71) Applicant: Axlen, Inc., Wilmington, DE (US)

(72) Inventor: Bo Pi, Carlsbad, CA (US)

(21) Appl. No.: 14/084,530

(22) Filed: Nov. 19, 2013

Related U.S. Application Data
(60) Provisional application No. 61/728,225, filed on Nov. 19, 2012.

(51) Int. Cl. H04B 10/116; G06Q 30/02; G06Q 30/06

(52) U.S. Cl. CPC H04B 10/116; G06Q 30/0623; G06Q 30/0241
USPC 705/14.4; 398/118; 705/26.61

(57) ABSTRACT

A lighting system for using illumination light of light emitting diodes (LEDs) to provide one-way data communication to user mobile communication devices is described. The lighting system includes illumination lighting devices at different locations within an area to emit visible illumination light illuminating the area. Each illumination lighting device includes: one or more LEDs producing visible illumination light; and a device lighting control circuit that modulates the visible illumination light to carry data and to broadcast the data in an illuminated area of the respective illumination lighting device which is modulated to carry the data. Each illumination lighting device also includes a device memory to locally store the data which is modulated onto the visible illumination light; and a device memory control circuit that updates the data stored in the device memory.

### CROSS-REFERENCE TO RELATED APPLICATIONS

This patent document claims the benefit of priority of U.S. Provisional Patent Application No. 61/728,225, filed on Nov. 19, 2012. The entire content of the before-mentioned patent application is incorporated by reference as part of the disclosure of this application.

### BACKGROUND

This patent document relates to systems, devices, and processes that provide data communications based on illumination light from light-emitting diodes in illumination lighting systems.

Light-emitting diodes (LED) are semiconductor light sources that can be used in lighting devices or systems to provide illumination light as energy-efficient alternatives to lighting devices or systems based on fluorescent light sources or candescent light bulbs.

### SUMMARY

Techniques, systems, and devices are described for implementing light emitting diode (LED)-based lighting devices or systems for producing both illumination light and data communications via the illumination light.

In one aspect, a method for using illumination light of light emitting diodes (LEDs) to provide one-way data communication to user mobile communication devices is described. More specifically, the method includes providing illumination lighting devices at different locations within an area to illuminate the area by operating LEDs in the illumination lighting devices to emit visible illumination light. The method also includes modulating the visible illumination light from one or more of the illumination lighting devices to carry data and to broadcast the data in an illuminated area of a respective illumination lighting device that is modulated. In particular, the data modulated onto the respective visible illumination light from the respective illumination lighting device is associated with a location of the respective illumination lighting device in the area to enable a light sensor and a data detection circuit in a user mobile communication device to receive the data without a reverse communication from the user mobile communication device to the illumination lighting device.

In some implementations, the method also includes modulating visible illumination light from a respective illumination lighting device to carry location indication data that indicates a location of the respective illumination lighting device in the area to allow a user mobile communication device to recover the location.

In some implementations, the area is a parking lot having different parking slots for parking automobiles and the illumination lighting devices are distributed at different locations in the parking lot in a way that each illumination lighting device is associated with one parking slot or a limited number of adjacent parking slots to enable a user mobile communication device of a driver to store the parking slot location for assisting the driver to locate a parked automobile.

In some implementations, the modulated visible illumination light includes a parking lot map in additional to the location indication data to enable the user mobile communication device to display the parking lot map and the location on the parking lot map.

In some implementations, the method includes grouping the illumination lighting devices in the area into different groups where each group includes selected illumination lighting devices adjacent to one another at a location different from a location of another group of differently selected illumination lighting devices. The method additionally includes controlling the modulating of the visible illumination light from one group of selected illumination lighting devices to carry group data which is common to each of the selected illumination lighting devices of the group while being different common data for at least one other group of selected illumination lighting devices.

In some implementations, the area is a retail store having different categories of products on sale that are placed at different merchandise areas. The method further includes controlling the modulating of the visible illumination light from one group of selected illumination lighting devices to carry group data which is associated with one or more categories of products on sale in the location of the group.

In some implementations, the method includes controlling the modulating of the visible illumination light from one group of selected illumination lighting devices to carry, in addition to the group data which is associated with one or more categories of products on sale in the location of the group, an advertisement or discount coupon of one or more products within the one or more categories of products on sale in the location of the group.

In some implementations, the method also includes controlling the modulating of the visible illumination light from one group of selected illumination lighting devices to carry, in addition to the group data which is associated with one or more categories of products on sale in the location of the group, an advertisement or discount coupon of another product or service which is associated with one or more products within the one or more categories of products on sale in the location of the group but does not belong to the one or more categories of products on sale in the location of the group.

In some implementations, the method includes: providing, at each illumination lighting device, a device optical receiver for receiving a programming optical beam which is modulated to carry the data to be programmed to a respective illumination lighting device; providing, at each illumination lighting device, a device memory to receive the data which is recovered from the programming optical beam received by the device optical receiver; and controlling the device memory at each illumination lighting device to replace existing data with newly received data which is recovered from the programming optical beam received by the device optical receiver, thus allowing each illumination lighting device to be reprogrammed with new data.

In some implementations, the method includes operating an optical programming unit to produce the programming optical beam which is modulated to carry the data to be programmed to a respective illumination lighting device, wherein the optical programming unit is separate from the illumination lighting devices.

In some implementations, the optical programming unit is a portable device.

In some implementations, the optical programming unit produces IR light for the programming optical beam.

In another aspect, a lighting system for using illumination light of LEDs to provide one-way data communication to user mobile communication devices is described. The lighting system includes illumination lighting devices at different locations within an area to emit visible illumination light illuminating the area. Each illumination lighting device includes: one or more LEDs producing visible illumination light; and a device lighting control circuit that modulates the visible illumination light to carry data and to broadcast the data in an illuminated area of the respective illumination lighting device which is modulated to carry the data. In particular, the data modulated onto the respective visible illumination light from the respective illumination lighting device is associated with a location of the respective illumination lighting device in the area to enable a light sensor and a data detection circuit in a user mobile communication device to receive the data without a reverse communication from the user mobile communication device to the illumination lighting device. Each illumination lighting device also includes a device memory to locally store the data which is modulated onto the visible illumination light; and a device memory control circuit that updates the data stored in the device memory.

In some implementations, the area is a parking lot having different parking slots for parking automobiles. Moreover, the illumination lighting devices are distributed at different locations in the parking lot in a way that each illumination lighting device is associated with one parking slot or a limited number of adjacent parking slots to enable a user mobile communication device of a driver to store the parking slot location for assisting the driver to locate a parked automobile.

In some implementations, the modulated visible illumination light includes a parking lot map in additional to the location indication data to enable the user mobile communication device to display the parking lot map and the location on the parking lot map.

In some implementations, the illumination lighting devices in the area are grouped into different groups where each group includes selected illumination lighting devices adjacent to one another at a location different from a location of another group of differently selected illumination lighting devices. The system also includes a mechanism that controls the modulating of the visible illumination light from one group of selected illumination lighting devices to carry group data which is common to each of the selected illumination lighting devices of the group while being different common data for at least one other group of selected illumination lighting devices.

In some implementations, the area is a retail store having different categories of products on sale that are placed at different merchandise areas. The modulating of the visible illumination light from one group of selected illumination lighting devices is controlled to carry group data which is associated with one or more categories of products on sale in the location of the group.

In some implementations, the modulating of the visible illumination light from one group of selected illumination lighting devices is controlled to carry, in addition to the group data which is associated with one or more categories of products on sale in the location of the group, an advertisement or discount coupon of one or more products within the one or more categories of products on sale in the location of the group.

In some implementations, the modulating of the visible illumination light from one group of selected illumination lighting devices is controlled to carry, in addition to the group data which is associated with one or more categories of products on sale in the location of the group, an advertisement or discount coupon of another product or service which is associated with one or more products within the one or more categories of products on sale in the location of the group but does not belong to the one or more categories of products on sale in the location of the group.

In yet another aspect, an illumination lighting device includes: one or more light emitting diodes (LEDs) for producing visible illumination light; an optical data receiver for receiving a programming optical beam which is encoded with data; a microcontroller unit (MCU) for decoding the data after the data is recovered from the programming optical beam; a device memory for receiving the decoded data and for locally storing the decoded data; and a lighting control circuit for modulating the visible illumination light to carry the data stored in the device memory and to broadcast the data in an illuminated area of the illumination lighting device.

In some implementations, the illumination lighting device also includes a memory control circuit for replace existing data stored in the device memory with the newly received data, thereby allowing the illumination lighting device to be reprogrammed with newly received data.

In some implementations, the optical data receiver is an infrared optical data receiver.

In some implementations, the optical data receiver is operable to recover the data from the programming optical beam.

### BRIEF DESCRIPTION OF THE DRAWINGS

FIG. 1 shows an example of a light emitting diode (LED) lighting device for both producing illumination light and for sending data modulated onto the illumination light in accordance with some embodiments described herein.

FIG. 2 shows an LED lighting system that includes multiple of the LED lighting devices shown in FIG. 1 in accordance with some embodiments described herein.

FIG. 3 shows an example of a user mobile communication device which is equipped with a light sensor for receiving illumination light and a data recovery circuit for extracting data modulated onto the illumination light in accordance with some embodiments described herein.

FIG. 4 shows another example where multiple user mobile communication devices are located in the illuminated area of the LED lighting system in FIG. 2 in accordance with some embodiments described herein.

FIG. 5A shows an exemplary LED lighting device which includes an optical receiver to enable manual programming of the data by receiving data or updating the data via a programming optical beam in accordance with some embodiments described herein.

FIG. 5B presents a flowchart illustrating an exemplary operation of the system described in FIG. 5A in accordance with some embodiments described herein.

FIG. 6 shows an exemplary application of the LED lighting system in FIG. 2 where multiple LED illumination lighting devices are fixed in different locations in a given area (such as a retail store or a parking lot) in accordance with some embodiments described herein.

### DETAILED DESCRIPTION

Techniques, systems, and devices are described for implementing light emitting diode (LED)-based lighting devices or systems for producing both illumination light and data communications via the illumination light.

In one aspect, a method for using illumination light LEDs to provide one-way data communication to user mobile communication devices is described. More specifically, the method includes providing illumination lighting devices at different locations within an area to illuminate the area by operating LEDs in the illumination lighting devices to emit visible illumination light. The method also includes modulating the visible illumination light from one or more of the illumination lighting devices to carry data and to broadcast the data in an illuminated area of a respective illumination lighting device that is modulated. In particular, the data modulated onto the respective visible illumination light from the respective illumination lighting device is associated with a location of the respective illumination lighting device in the area to enable a light sensor and a data detection circuit in a user mobile communication device to receive the data without a reverse communication from the user mobile communication device to the illumination lighting device.

In another aspect, a lighting system for using illumination light of LEDs to provide one-way data communication to user mobile communication devices is described. The lighting system includes illumination lighting devices at different locations within an area to emit visible illumination light illuminating the area. Each illumination lighting device includes: one or more LEDs producing visible illumination light; and a device lighting control circuit that modulates the visible illumination light to carry data and to broadcast the data in an illuminated area of the respective illumination lighting device that is modulated to carry the data. In particular, the data modulated onto the respective visible illumination light from the respective illumination lighting device is associated with a location of the respective illumination lighting device in the area to enable a light sensor and a data detection circuit in a user mobile communication device to receive the data without a reverse communication from the user mobile communication device to the illumination lighting device. Each illumination lighting device also includes a device memory to locally store the data which is modulated onto the visible illumination light; and a device memory control circuit that updates the data stored in the device memory.

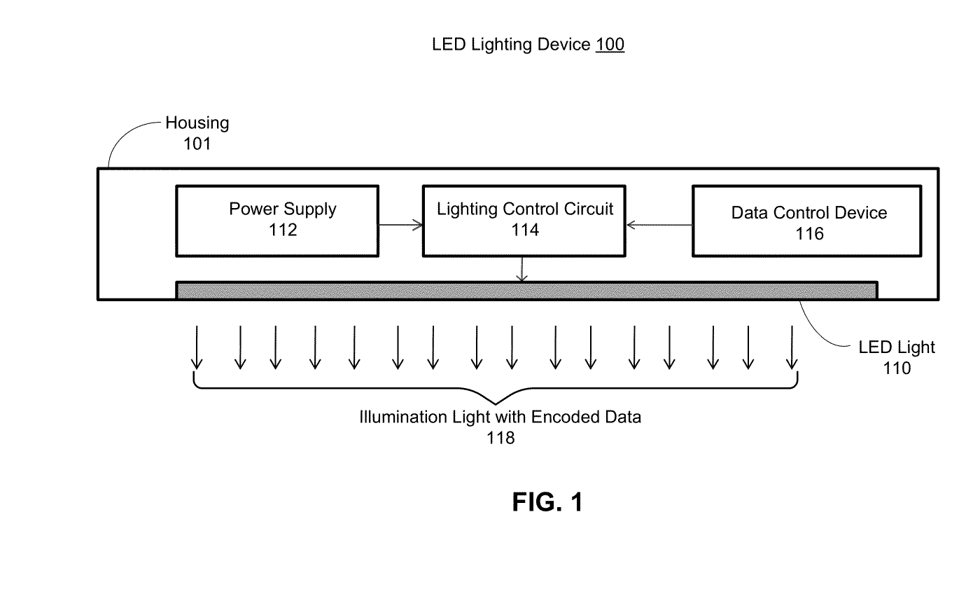

FIG. 1 shows an example of a light emitting diode (LED) lighting device 100 for both producing illumination light and for sending data modulated onto the illumination light in accordance with some embodiments described herein. LED lighting device 100 includes a housing 101 that encloses a power supply 112 which is connected to the power grid to receive power and to convert received AC power to DC power for powering one or more LEDs in the LED light 110. LED lighting device 100 also includes a lighting control circuit 114 that provides a current to LED light 110. For example, lighting control circuit 114 can generate a constant current for illumination and a modulated current that carries data. LED lighting device 100 further includes a data control device 116 that can include a device memory that stores data and a memory controller that updates the stored data in the memory. The data from the data control device 116 is supplied to the lighting control circuit 114 to modulate the current to carry the data.

In yet another aspect, an illumination lighting device includes: one or more LEDs for producing visible illumination light; an optical data receiver for receiving a programming optical beam which is encoded with data; a microcontroller unit (MCU) for decoding the data after the data is recovered from the programming optical beam; a device memory for receiving the decoded data and for locally storing the decoded data; and a lighting control circuit for modulating the visible illumination light to carry the data stored in the device memory and to broadcast the data in an illuminated area of the illumination lighting device.

In some implementations, the data control device 116 can be networked to receive the data via a wireless or wired communication link. In other implementations, the data control device 116 can be manually programmed to receive or update the data. LED lighting device 100 can be used to illuminate an area surrounding the device, and in some embodiments, to provide one-way data communication to one or more user mobile communication devices under the illumination of the modulated light output by the LED lighting device 100. As further explained below, the data modulated onto the illumination light 118 emitted by the lighting device 100 can be associated with a location of the LED lighting device 100 in the area to enable a light sensor and a data detection circuit in a user mobile communication device to receive the data without a reverse communication from the user mobile communication device to the LED lighting device 100.

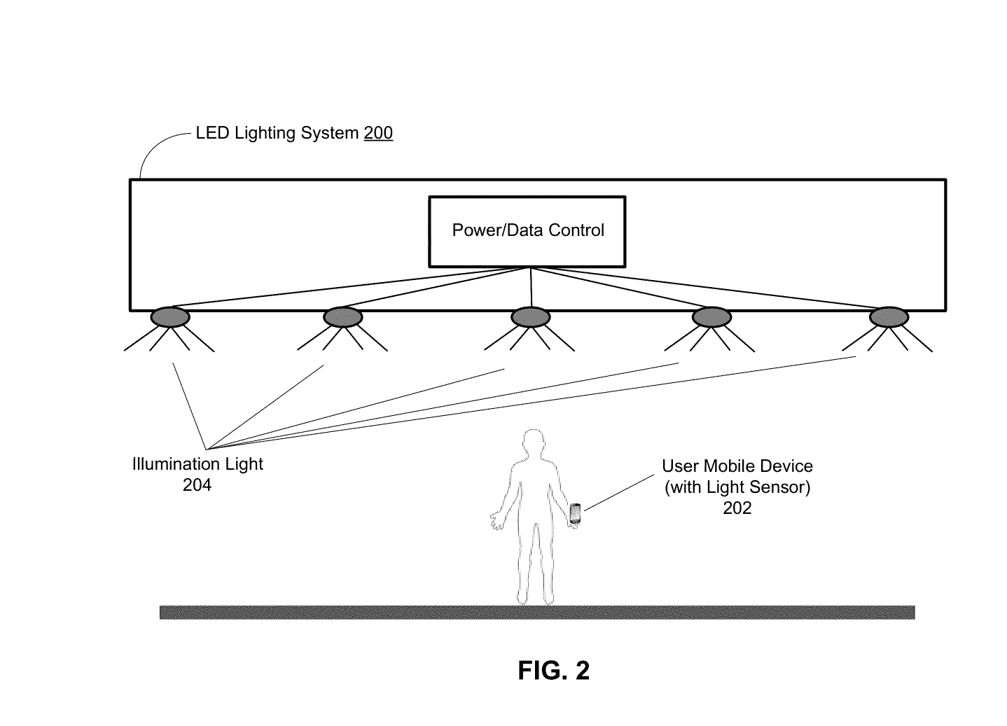

FIG. 2 shows an LED lighting system 200 that includes multiple of the LED lighting devices shown in FIG. 1 in accordance with some embodiments described herein. As illustrated in FIG. 2, a user mobile device 202 with a light sensor can receive the illumination light 204 and thus receive the data modulated onto the illumination light 204.

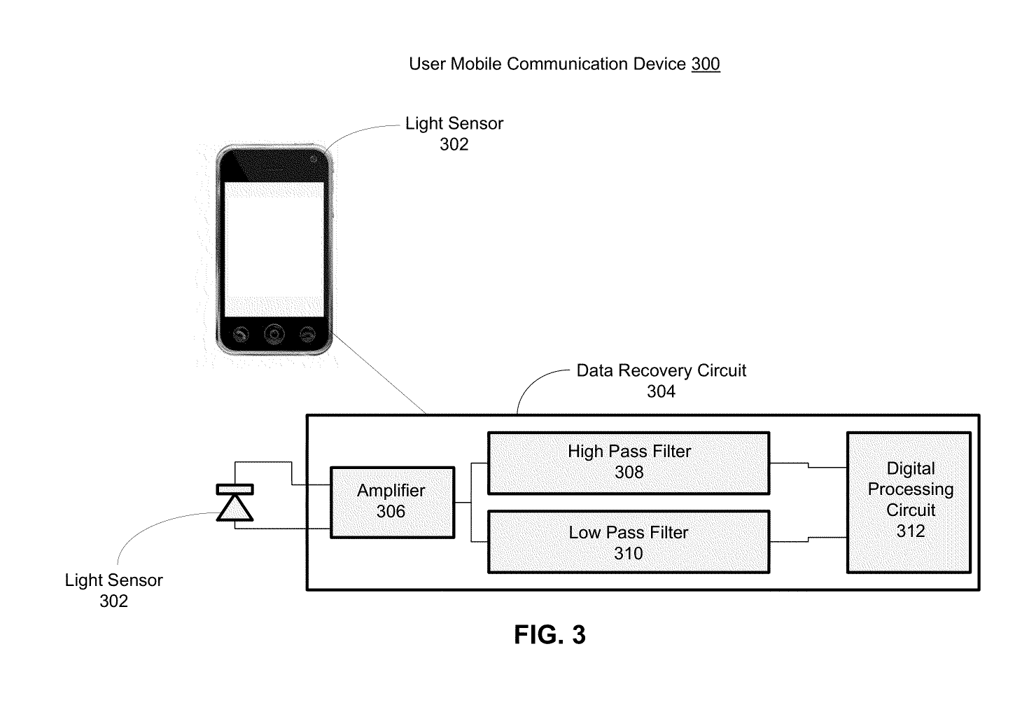

FIG. 3 shows an example of a user mobile communication device 300 which is equipped with a light sensor 302 for receiving illumination light and a data recovery circuit 304 for extracting data modulated onto the illumination light in accordance with some embodiments described herein. In the example shown, the data recovery circuit 304 includes an amplifier 306 to amplify the output of the light sensor 302. The data recovery circuit 304 also includes a high pass filter 308 for filtering the light sensor 302 output to produce a data signal to be used for decoding the encoded data and extracting the data, and a low pass filter 310 for producing a signal representing the ambient light level. The data recover circuit 304 further includes a digital processing circuit 312 (e.g., CPU/MCU) that decodes the data signal and extracts the data. The extracted data is then used by a software application on the device. Such a user mobile communication device 300 can be a mobile phone, a smart phone, a tablet or a mobile computer.

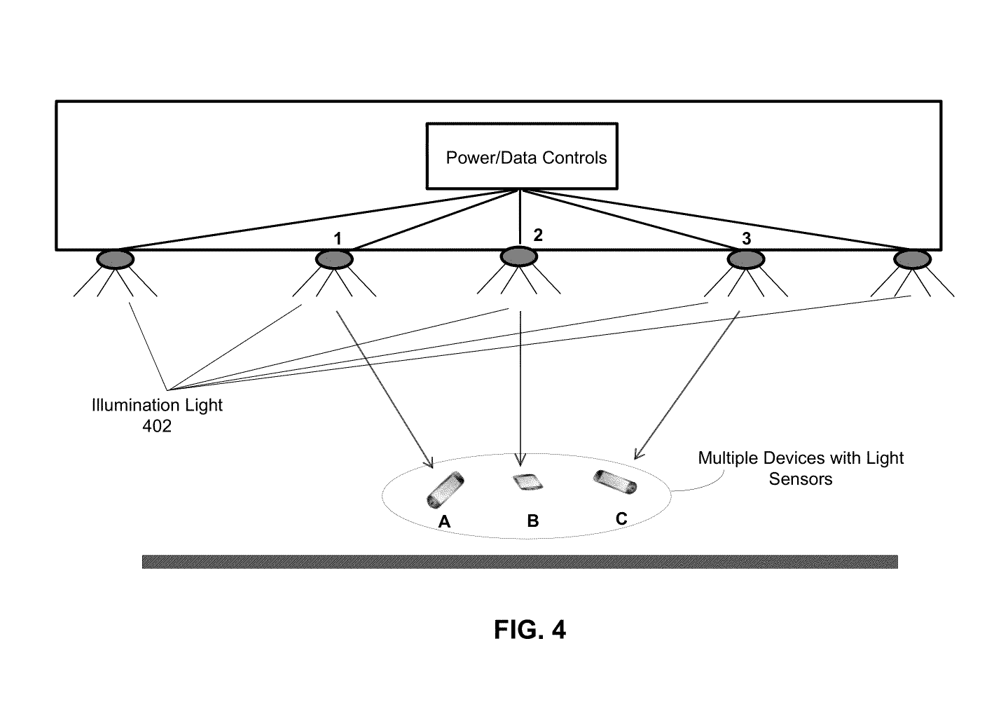

FIG. 4 shows another example where multiple user mobile communication devices (e.g., user mobile devices A, B, and C) are located in the illuminated area of the LED lighting system 200 in FIG. 2 in accordance with some embodiments described herein. During operation, a user can tilt a user mobile device A, B, or C to receive data-carrying illumination light 402 from different lighting devices (e.g., from one of the lighting devices 1, 2, or 3).

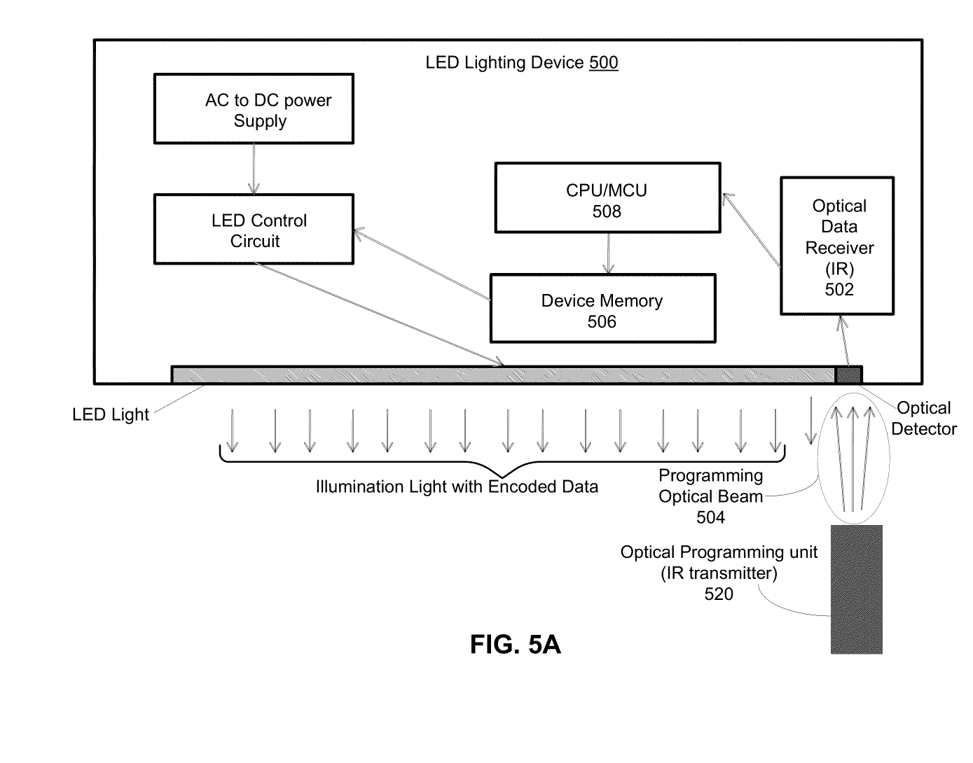

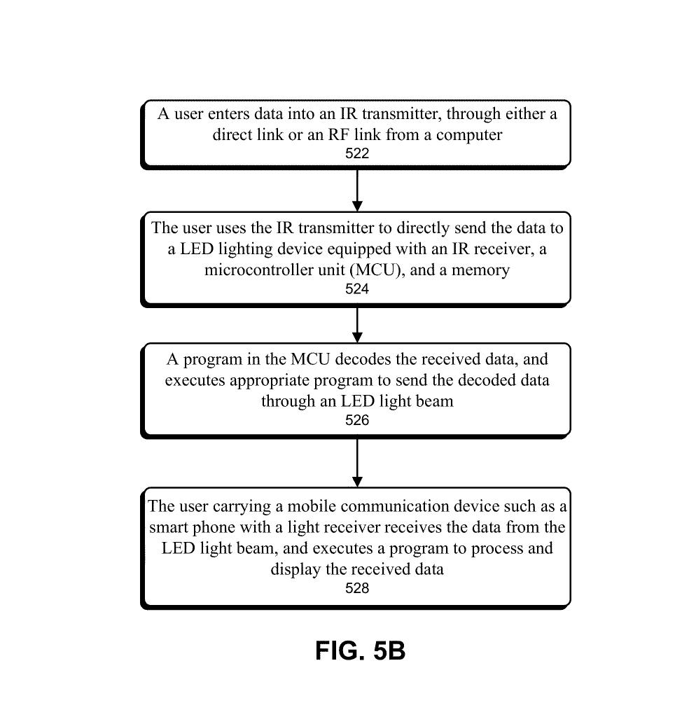

FIG. 5A shows an exemplary LED lighting device 500 which includes an optical data receiver 502 to enable manual programming of the data by receiving data or updating the data via a programming optical beam 504 in accordance with some embodiments described herein. As illustrated in FIG. 5A, the LED lighting device 500 includes the optical data receiver 502, a device memory 506 and a microcontroller unit (MCU) 508. Optical data receiver 502 is configured to receive the programming optical beam 504 which is encoded with data and can also recover the data from the programming optical beam 504. MCU 508 is configured to decode the data. Device memory 506 within the LED lighting device 500 is configured to receive the decoded data. Device memory 506 may be controlled (e.g., using a memory controller) to replace existing data with newly received data which is recovered from the programming optical beam 504 received by the optical data receiver 502, thus allowing the LED lighting device 500 to be reprogrammed with new data.

In the example in FIG. 5A, the optical data receiver 502 is shown as an infrared (IR) receiver. In some implementations, LED lighting device 500 in FIG. 5A is among a group of LED lighting devices 500. Note that a separate optical programming unit 520 (e.g., an IR transmitter) is used to produce the programming optical beam 504 which is modulated to carry the data to be programmed to a respective LED lighting device 500. An operator can manually use this optical programming unit to upload the appropriate data onto each of the lighting devices 500. For example, the uploaded data can be the location or ID number of the lighting device in some applications. Under this operation, the uploaded data remains fixed until the next manual programming operation. This programming technique allows updating an existing lighting system by replacing the existing illumination lights with the data-carrying illumination light in FIG. 5A without changing the electrical layout or other system-level infrastructure of the lighting system.

FIG. 5B presents a flowchart illustrating an exemplary operation of the system described in FIG. 5A in accordance with some embodiments described herein. During operation, a user enters data into an IR transmitter, through either a direct link or an RF link from a computer (step 522). Next, the user uses the IR transmitter to directly send the data to a LED lighting device equipped with an IR receiver, a microcontroller unit (MCU), and a memory (step 524). A program in the MCU then decodes the received data, and subsequently executes an appropriate program to send the decoded data through an LED light beam (step 526). The user carrying a mobile communication device such as a smart phone with light receiver then receives the data from the LED light beam, and executes a program to process and display the received data (step 528).

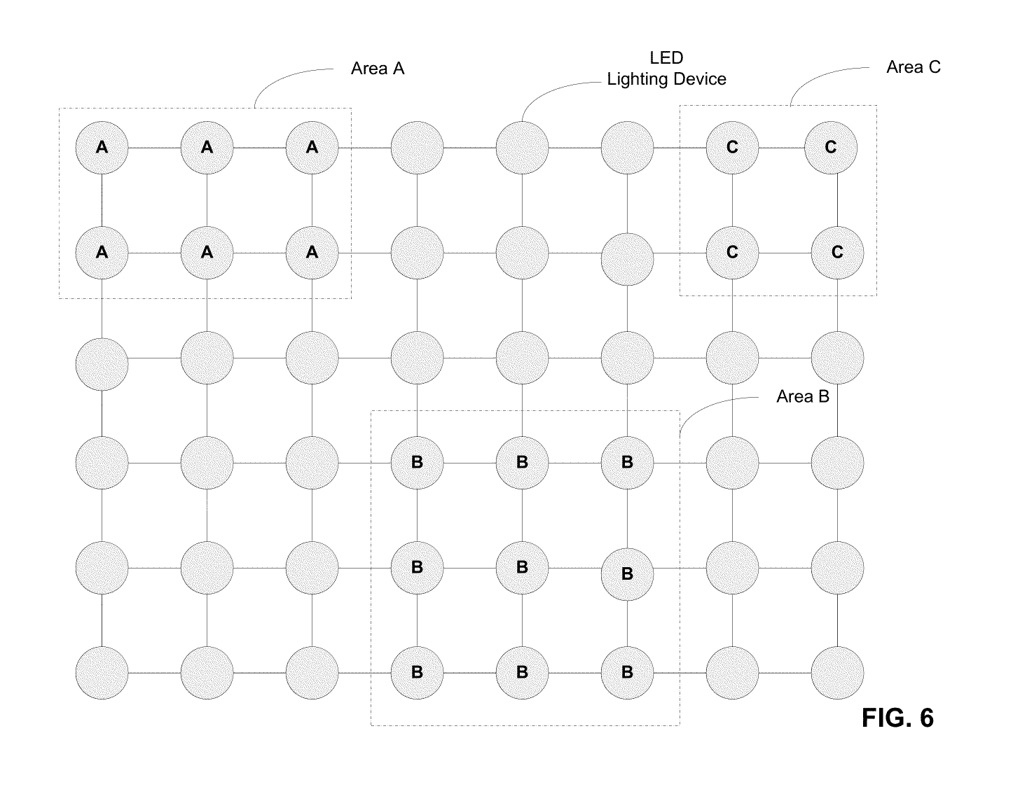

FIG. 6 shows an exemplary application of the LED lighting system 200 in FIG. 2 where multiple LED illumination lighting devices are fixed in different locations in a given area (such as a retail store or a parking lot) in accordance with some embodiments described herein. As shown in FIG. 6, the grid illustrates that the LED devices are arranged in rows and columns. In other implementations, the LED devices may also be arranged in other geometries.

Further referring to FIG. 6, note that in some implementations, each LED device is at a known location, e.g., row x and column y based on a predetermined coordinate system at the location, or represented by geographic coordinates in terms of latitude and longitude parameters. The location of each LED device can be included in the data transmitted or broadcast by the modulated illumination light from the LED device. As such, a user mobile communication device can associate the received data with the location of the sending LED device. This correlation between the received data and the location of the LED device can have many location-based applications.

For example, the system in FIG. 6 can be used in an outdoor or indoor parking structure to use the LED lighting devices to assist drivers to locate their vehicles. Consider an example where the area shown in FIG. 6 is a parking lot having different parking slots for parking automobiles. In this example, the LED illumination lighting devices are distributed at different locations in the parking lot in a way that each illumination lighting device is associated with one parking slot or a limited number of adjacent parking slots to enable a user mobile communication device of a driver to store the parking slot location for assisting the driver to locate a parked automobile. After parking a car at a particular parking slot, the driver can use his mobile phone equipped with the light sensor and data processing features shown in FIG. 3 to receive the location data of a nearby LED lighting device, so that the mobile phone “remembers” the location of that particular LED lighting device near the parking slot. The driver can simply look up the location on the mobile phone when returning to retrieve the car. In some implementations, the modulated visible illumination light may include a parking lot map in addition to the location indication data to enable the user mobile communication device to display the parking lot map and the location on the parking lot map in order to better guide the driver to the proper parking slot. The existing parking structures can be upgraded with the LED devices described in FIG. 5A which are capable of broadcasting data without changing the electrical layout of the parking structure lighting system to provide this user-friendly parking assist function.

As another example, the lighting system in FIG. 6 may represent street lighting in a shopping district of a city where different shops or stores are located at or near different LED devices. Different LED lighting devices can be programmed with data associated with nearby stores to alert or inform people walking on the street of the products or services. A user mobile communication device capable of receiving data from the illumination light can include a software application that dynamically downloads data from the LED lighting devices and alerts by sound or graphics or other indicators to inform what is around. In addition, the LED lighting devices may also carry an advertisement or discount coupon of one or more products of nearby shops to users. As a user passes by different LED lighting devices on the street, the data received by the user mobile communication device changes accordingly.

In FIG. 6, the LED illumination lighting devices in the area can be grouped into different groups wherein each group includes selected illumination lighting devices adjacent to one another at a location different from a location of another group of differently selected illumination lighting devices. For example, Areas A, B and C represent 3 different exemplary groups (Groups A, B and C, respectively) within the area associated with FIG. 6. The modulating of the visible illumination light from one group of selected illumination lighting devices carry group data which is common to each of the selected illumination lighting devices of the group (e.g., Group A) while being different from common data for at least one other group of selected illumination lighting devices (e.g., Groups B and C). This location-based data service is group-based and has applications in various situations.

For example, the area in FIG. 6 can be a retail store having different categories of products on sale that are placed at different merchandise areas, e.g., aisles or sections in supermarkets or a department store. The modulating of the visible illumination light from one group of selected illumination lighting devices can be controlled to carry group data which is associated with one or more categories of products on sale in the location of the group. For example, Area A can be the meat section in a supermarket while Area B is the vegetable section and Area C is the cosmetic section. The LED devices in these different areas can carry different advertisement or coupons to the shoppers. As such, the modulating of the visible illumination light from one group of selected illumination lighting devices can be controlled to carry, in addition to the group data which is associated with one or more categories of products on sale in the location of the group, an advertisement or discount coupon of one or more products within the one or more categories of products on sale in the location of the group.

In addition, the LED data can be used to provide information on related products or services that are different from the products or services at the current location but have some connection with the products or services at the current location. For example, a user may be shopping at the meat section of the supermarket while the LED lighting data can include not only the ads or coupons for various meat products at the current location but also suggestions of wines or spices associated with the meat products. Therefore, the modulating of the visible illumination light from one group of selected illumination lighting devices can be controlled to carry, in addition to the group data which is associated with one or more categories of products on sale in the location of the group, an advertisement or discount coupon of another product or service which is associated with one or more products within the one or more categories of products on sale in the location of the group but does not belong to the one or more categories of products on sale in the location of the group.

While this patent document contains many specifics, these should not be construed as limitations on the scope of any invention or of what may be claimed, but rather as descriptions of features that may be specific to particular embodiments of particular inventions. Certain features that are described in this patent document in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. Moreover, the separation of various system components in the embodiments described in this patent document should not be understood as requiring such separation in all embodiments.

Only a few implementations and examples are described and other implementations, enhancements and variations can be made based on what is described and illustrated in this patent document.

What is claimed is what is described and illustrated, including:

1. A method for using illumination light of light emitting diodes (LEDs) to provide one-way data communication to user mobile communication devices, comprising:
providing illumination lighting devices at different locations within an area to illuminate the area by operating light emitting diodes (LEDs) in the illumination lighting devices to emit visible illumination light; and
modulating the visible illumination light from one or more of the illumination lighting devices to carry data and to broadcast the data in an illuminated area of a respective illumination lighting device which is modulated to carry data in the respective visible illumination light, wherein the data modulated onto the respective visible illumination light from the respective illumination lighting device is associated with a location of the respective illumination lighting device in the area to enable a light sensor and a data detection circuit in a user mobile communication device to receive the data without a reverse communication from the user mobile communication device to the illumination lighting device.

2. The method as in claim 1, comprising:
modulating visible illumination light from a respective illumination lighting device to carry location indication data that indicates a location of the respective illumination lighting device in the area to allow a user mobile communication device to recover the location.

3. The method as in claim 2, wherein:
the area is a parking lot having different parking slots for parking automobiles and the illumination lighting devices are distributed at different locations in the parking lot in a way that each illumination lighting device is associated with one parking slot or a limited number of adjacent parking slots to enable a user mobile communication device of a driver to store the parking slot location for assisting the driver to locate a parked automobile.

4. The method as in claim 3, wherein the modulated visible illumination light includes a parking lot map in additional to the location indication data to enable the user mobile communication device to display the parking lot map and the location on the parking lot map.

5. The method as in claim 1, comprising:
grouping the illumination lighting devices in the area into different groups where each group includes selected illumination lighting devices adjacent to one another at a location different from a location of another group of differently selected illumination lighting devices; and
controlling the modulating of the visible illumination light from one group of selected illumination lighting devices to carry group data which is common to each of the selected illumination lighting devices of the group while being different common data for at least one other group of selected illumination lighting devices.

6. The method as in claim 5, wherein:
the area is a retail store having different categories of products on sale that are placed at different merchandise areas;
the method further comprises controlling the modulating of the visible illumination light from one group of selected illumination lighting devices to carry group data which is associated with one or more categories of products on sale in the location of the group.

7. The method as in claim 6, further comprising:
controlling the modulating of the visible illumination light from one group of selected illumination lighting devices to carry, in addition to the group data which is associated with one or more categories of products on sale in the location of the group, an advertisement or discount coupon of one or more products within the one or more categories of products on sale in the location of the group.

8. The method as in claim 6, further comprising:
controlling the modulating of the visible illumination light from one group of selected illumination lighting devices to carry, in addition to the group data which is associated with one or more categories of products on sale in the location of the group, an advertisement or discount coupon of another product or service which is associated with one or more products within the one or more categories of products on sale in the location of the group but does not belong to the one or more categories of products on sale in the location of the group.

9. The method as in claim 1, comprising:
providing, at each illumination lighting device, a device optical receiver for receiving a programming optical beam which is modulated to carry the data to be programmed to a respective illumination lighting device;
providing, at each illumination lighting device, a device memory to receive the data which is recovered from the programming optical beam received by the device optical receiver;
controlling the device memory at each illumination lighting device to replace existing data with newly received data which is recovered from the programming optical beam received by the device optical receiver, thus allowing each illumination lighting device to be reprogrammed with new data.

10. The method as in claim 9, comprising:
operating an optical programming unit to produce the programming optical beam which is modulated to carry the data to be programmed to a respective illumination lighting device, wherein the optical programming unit is separate from the illumination lighting devices.

11. The method as in claim 10, wherein the optical programming unit is a portable device.

12. The method as in claim 10, wherein the optical programming unit produces IR light for the programming optical beam.

13. A lighting system for using illumination light of light emitting diodes (LEDs) to provide one-way data communication to user mobile communication devices, comprising:
illumination lighting devices at different locations within an area to emit visible illumination light illuminating the area,
wherein each illumination lighting device includes:
one or more light emitting diodes (LEDs) producing visible illumination light;
a device lighting control circuit that modulates the visible illumination light to carry data and to broadcast the data in an illuminated area of the respective illumination lighting device which is modulated to carry the data, wherein the data modulated onto the respective visible illumination light from the respective illumination lighting device is associated with a location of the respective illumination lighting device in the area to enable a light sensor and a data detection circuit in a user mobile communication device to receive the data without a reverse communication from the user mobile communication device to the illumination lighting device;
a device memory to locally store the data which is modulated onto the visible illumination light; and
a device memory control circuit that updates the data stored in the device memory.

14. The system as in claim 13, wherein:
the area is a parking lot having different parking slots for parking automobiles; and
the illumination lighting devices are distributed at different locations in the parking lot in a way that each illumination lighting device is associated with one parking slot or a limited number of adjacent parking slots to enable a user mobile communication device of a driver to store the parking slot location for assisting the driver to locate a parked automobile.

15. The system as in claim 14, wherein the modulated visible illumination light includes a parking lot map in additional to the location indication data to enable the user mobile communication device to display the parking lot map and the location on the parking lot map.

16. The system as in claim 13, wherein:
the illumination lighting devices in the area are grouped into different groups where each group includes selected illumination lighting devices adjacent to one another at a location different from a location of another group of differently selected illumination lighting devices; and
a mechanism that controls the modulating of the visible illumination light from one group of selected illumination lighting devices to carry group data which is common to each of the selected illumination lighting devices of the group while being different common data for at least one other group of selected illumination lighting devices.

17. The system as in claim 16, wherein:
the area is a retail store having different categories of products on sale that are placed at different merchandise areas;
wherein the modulating of the visible illumination light from one group of selected illumination lighting devices is controlled to carry group data which is associated with one or more categories of products on sale in the location of the group.

18. The system as in claim 16, wherein:
the modulating of the visible illumination light from one group of selected illumination lighting devices is controlled to carry, in addition to the group data which is associated with one or more categories of products on sale in the location of the group, an advertisement or discount coupon of one or more products within the one or more categories of products on sale in the location of the group.

19. The system as in claim 16, wherein:
the modulating of the visible illumination light from one group of selected illumination lighting devices is controlled to carry, in addition to the group data which is associated with one or more categories of products on sale in the location of the group, an advertisement or discount coupon of another product or service which is associated with one or more products within the one or more categories of products on sale in the location of the group but does not belong to the one or more categories of products on sale in the location of the group.

20. An illumination lighting device, comprising:
one or more light emitting diodes (LEDs) operable to produce visible illumination light;
an optical data receiver operable to receive a programming optical beam which is encoded with data;
a microcontroller unit (MCU) operable to decode the data after the data is recovered from the programming optical beam;
a device memory operable to receive the decoded data and to locally store the decoded data; and
a lighting control circuit operable to modulate the visible illumination light to carry the data from the device memory and to broadcast the data in an illuminated area of the illumination lighting device.

21. The illumination lighting device of claim 20, further comprising a memory control circuit operable to replace existing data stored in the device memory with the newly received data, thereby allowing the illumination lighting device to be reprogrammed with newly received data.

22. The illumination lighting device of claim 20, wherein the optical data receiver is an infrared optical data receiver.

23. The illumination lighting device of claim 20, wherein the optical data receiver is operable to recover the data from the programming optical beam.
